(19) United States
(12) Patent Application Publication
(10) Pub. No.: US 2002/0028032 A1
(43) Pub. Date: Mar. 7, 2002

(54) Wheel Bearing assembly

(75) Inventor: Takayuki Norimatsu, Shizuoka (JP)

Correspondence Address: SUGHRUE, MION, ZINN, MACPEAK & SEAS, 2100 Pennsylvania Avenue, N.W., Washington, DC, 20037, US

(73) Assignee: NTN CORPORATION

(21) Appl. No.: 09/944,589

(22) Filed: Sep. 4, 2001

(30) Foreign Application Priority Data
Sep. 5, 2000 (JP) 2000-268198

(51) Int. Cl. F16C 32/00

(52) U.S. Cl. 384/448

(57) ABSTRACT

Provided is a wheel bearing assembly in which a magnetized encoder (20) can withstand severe temperature condition occurring around a vehicle wheel to thereby secure a high accuracy of detection of a rotational speed. The wheel bearing assembly includes a sealing device (5) interposed between inner and outer members (1 and 2). A rotary member which is defined by one of the inner and outer members (1 and 2) is provided with a magnetized encoder (20) having a series of alternating magnetic poles of opposite polarities. The magnetized encoder (20) constitutes the sealing device (5). The magnetized encoder (20) can maintain initial magnetic characteristics as regards the single pitch deviation and the magnetic flux density under predetermined thermal endurance test condition.

### BACKGROUND OF THE INVENTION

1. Field of the Invention

The present invention relates to a wheel bearing assembly for use in an automotive vehicle and, more particularly to a sealed structure integrated together with an encoder grid for detection of the rotational speed of automotive wheels.

2. Description of the Prior Art

In an antiskid brake system (ABS), it is necessary to detect the rotational speed of a vehicle wheel for control. As a means for detecting the wheel rotational speed, the use is known of a magnetized encoder in a wheel bearing assembly for detection of the wheel rotational speed.

By way of example, such a wheel bearing assembly as shown in FIG. 9 has been well known in which a sealing device 105 is interposed between an inner member 101 and an outer member 102 with a circular row of rolling elements 103 rollingly interposed between the inner and outer members 101 and 102. In this wheel bearing assembly, a magnetized encoder 106 is integrated together with the sealing device 105 such as disclosed in, for example, the Japanese Laid-open Patent Publication No. 6-281018. The sealing device 105 includes first and second sealing plates 107 and 108 of a generally L-shaped section mounted to the inner and outer members 101 and 102, respectively, with the second sealing plate 108 being provided with a resilient lip 109. The first sealing plate 107 is generally referred to as a slinger. The magnetized encoder 106 is prepared from an elastic material mixed with a powder of magnetic material and is bonded by vulcanization to the first sealing plate 107. This magnetized encoder 106 is of a design in which magnetic poles of opposite polarities are formed alternately in a direction circumferentially thereof and is detected by a magnetic sensor 110 disposed in face-to-face relation therewith.

As is well known to those skilled in the art, vehicle wheels are placed under severe environment in which the temperature ranges from a low value of some tens degree Celsius to a high value in excess of 100° C. and yet varies repeatedly. For this reason, in the wheel bearing assembly, the magnetized encoder 106 undergoes a considerable change in temperature affected by the environmental temperature. Considering that the magnetized encoder 106 contains not only the elastic material such as rubber or the like, but also the powder of the magnetizeable material such as, for example, ferrite and the bonding strength of the rubber as a binder is relatively low, it often occurs that under the influence of a considerable change in temperature to which the magnetized encoder 106 is repeatedly subjected, fine cracking tends to occur, failing to sustain the initial magnetic characteristic at a satisfactory level. Reduction in magnetic characteristic of the magnetized encoder 106 leads to reduction in accuracy with which the rotational speed of the vehicle wheel is detected and, therefore, a proper and normal operation of, for example, the antiskid brake system will no longer be warranted.

In view of the foregoing, the present invention is intended to provide an improved wheel bearing assembly in which the magnetized encoder can withstand against the severe thermal condition to thereby ensure the accuracy of detection of the rotational speed.

The present invention also has another object to provide an improved wheel bearing assembly of the type referred to above, which can be manufactured compact in size with a minimized number of component parts with both the number of component parts and the number of process steps reduced, even though the magnetized encoder is utilized therein.

### SUMMARY OF THE INVENTION

In order to accomplish these objects of the present invention, there is provided a wheel bearing assembly which includes an inner member, an outer member, at least one circumferential row of rolling elements rollingly interposed between the inner and outer members, a sealing device for sealing an annular end space defined between the inner and outer members, and a magnetized encoder mounted on one of the inner and outer members which serves as a rotary member. The magnetized encoder in turn includes an elastic member made of a base material mixed with a powder of magnetic material. The elastic member is bonded by vulcanization to the magnetized encoder and has a series of alternating magnetic poles of opposite polarities formed in a direction circumferentially of the rotary member. Under a thermal endurance test condition in which the magnetized encoder is subjected to 1,000 thermal cycles each consisting of heating at 120° C. for one hour followed by cooling at −40° C. for one hour, the magnetized encoder retains the following initial magnetic characteristics when an air gap defined between the magnetized encoder and a magnetic sensor for detecting the magnetic poles thereof is 2.0 mm:

Single pitch deviation: ±2% or less and

Magnetic flux density: ±3 mT or higher.

The term “single pitch deviation” referred to herein represents a maximum value of displacement from a target pitch determined by measuring a pitch of an output waveform for one complete rotation obtained by the magnetic sensor when the elastic member is rotated one complete rotation. The smaller the single pitch deviation, the higher the accuracy of detection of the rotational speed.

According to the present invention, since one of the inner and outer members which serves as a rotary member has the magnetized encoder fitted thereto, positioning of the magnetic sensor in face-to-face relation with this magnetized encoder is effective to achieve detection of the rotational speed of the rotary member.

The thermal endurance test condition referred to above correspons to the actual specification. Since the magnetized encoder when placed under the thermal endurance test condition corresponding to the actual specification, retains the initial magnetic characteristics as discussed above, the initial magnetic characteristics can be maintained even under the severe condition of use which is predominant around the vehicle wheel.

In the practice of the present invention, the single pitch deviation within that range and the magnetic flux density within that range can be obtained by selecting materials for the base material of the elastic member, and for the powder of the magnetic material, and/or adjusting a mixing ratio of the magnetic material to the base material (wt %).

Also, in the practice of the present invention, the magnetized encoder may define the sealing device.

As such, as compared with the case in which the magnetized encoder is employed separate from the sealing device, the bearing assembly can be manufactured compact in size with minimized number of component parts and with minimized number of assembling steps.

Where the magnetized encoder defines the sealing device, the magnetized encoder may have a generally L-shaped section including a cylindrical portion mounted on the rotary member and a radial upright portion extending radially outwardly from the cylindrical portion, wherein the radial upright portion has a radial outer edge spaced a slight distance from the other of the inner and outer members which serves as a stationary member.

According to this preferred design, a portion where the radial upright portion has a radial outer edge spaced a slight distance from the other of the inner and outer members which serves as a stationary member provides a function as a labyrinth seal. Also, since the magnetized encoder has the cylindrical portion, mounting onto the rotary member can be achieved easily and readily.

In the practice of the present invention, where the magnetized encoder defines the sealing device, the sealing device may include first and second annular sealing plates fitted to members of the inner and outer members that are different from each other. In this case, the first and second annular sealing plates have to be of a generally L-shaped section each including a cylindrical portion and a radial upright portion and confront with each other. The first sealing plate is mounted on one of the inner and outer members which serves as the rotary member with the radial upright portion thereof positioned on an outer side of the bearing assembly. At the same time, the elastic member mixed with the powder of the magnetic material is bonded by vulcanization to the radial upright portion of the first sealing plate and has the alternating magnetic poles of the opposite polarities defined therein in the direction circumferentially thereof. On the other hand, the second sealing plate is preferably provided with a side lip slidingly engaged with the radial upright portion of the second sealing plate and a radial lip slidingly engaged with the cylindrical portion of the second sealing plate. In this structure, the radial upright portion of the first sealing plate has a radial outer edge spaced the slight distance radially from the cylindrical portion of the second sealing plate.

According to this feature, as a sealing function for sealing between the inner and outer members, both a contact sealing achieved by a sliding contact of the sealing lips provided in the second sealing plate and a labyrinth seal defined in a radial gap between the cylindrical portion of the second sealing plate and the radial outer edge of the radial upright portion of the first sealing plate can be obtained.

Preferably the elastic member is made of a heat resistant nitrile rubber. Specifically, the elastic member may be made of a heat resistant nitrile rubber as the base material which is mixed with the powder of the magnetic material.

The use of the heat resistant nitrile rubber as the base material is effective to minimize deterioration of the elastic member under severe temperature conditions such as described above, allowing the initial magnetic characteristics to be maintained advantageously.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a longitudinal sectional view of a wheel bearing assembly according to a first preferred embodiment of the present invention;

FIG. 2 is a fragmentary plan view of a magnetized encoder employed in the wheel bearing assembly shown in FIG. 1;

FIG. 3 is a fragmentary longitudinal sectional view, on an enlarged scale, showing a portion of the wheel bearing assembly of FIG. 1 where the magnetized encoder is positioned;

FIG. 4 is an explanatory chart showing one example of a heat pattern applied to the magnetized encoder during a thermal endurance test;

FIG. 5 is an explanatory chart showing another example of the heat pattern applied to the magnetized encoder during the thermal endurance test;

FIG. 6 is a longitudinal sectional view of the wheel bearing assembly according to a second preferred embodiment of the present invention;

FIG. 7 is a fragmentary longitudinal sectional view, on an enlarged scale, showing a portion of the wheel bearing assembly of FIG. 6 where the magnetized encoder is positioned;

FIG. 8 is a longitudinal sectional view of the wheel bearing assembly according to a third preferred embodiment of the present invention; and

FIG. 9 is a fragmentary longitudinal sectional view showing a portion of the prior art wheel bearing assembly.

### DETAILED DESCRIPTION OF THE EMBODIMENTS

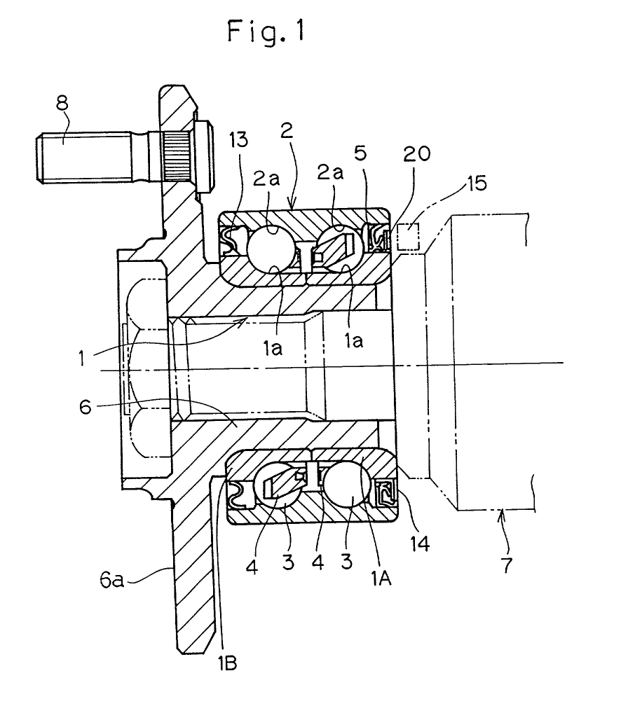

A first preferred embodiment of the present invention will first be described with reference to FIGS. 1 to 5. In describing the first embodiment, reference will be made to the wheel bearing assembly that is used to support a vehicle drive wheel, in which the magnetized encoder is concurrently used as a sealing slinger.

As shown in FIG. 1, the wheel bearing assembly includes an inner member 1, an outer member 2, two rows of rolling elements 3 rollingly interposed between the inner and outer members 1 and 2, and annular sealing devices 5 and 13 for sealing opposite ends of an annular space delimited between the inner and outer members 1 and 2, respectively. The sealing device 5 positioned at one of the opposite ends of the annular space remote from the drive wheel is equipped with a magnetized encoder 20 as will be described in detail later. The inner and outer members 1 and 2 have their mutually confronting inner surfaces formed with respective raceways 1a and 2a each being in the form of a circumferentially extending groove for accommodating respective rows of the rolling elements 3. The inner member 1 referred to above is a member positioned radially inwardly of the rows of the rolling elements 3 whereas the outer member 2 referred to above is a member positioned radially outwardly of the rows of the rolling elements 3. The inner and outer members 1 and 2 may be inner and outer races that are generally utilized in any bearing, respectively, or the bearing inner and outer races that are combined with separate component parts, respectively. Alternatively, the inner member 1 may be a shaft. The rolling elements 3 may be balls or rollers, but in the illustrated embodiment the balls are employed for the rolling elements 3 of the two rows.

The illustrated wheel bearing assembly is in the form of a double row rolling bearing, more particularly, a double row angular ball bearing, having a bearing inner race comprised of a pair of split inner race segments 1A and 1B, each of which has the raceway 1a. The inner race segments 1A and 1B are mounted in end-to-end fashion around a stud portion of a hub wheel 6 so as to define the inner member 1 together with the hub wheel 6. It is, however, to be noted that instead of the use of the three components including the hub wheel 6 and the split inner race segments 1A and 1B discussed above, the bearing inner race may be of a two component type made up of a hub wheel 6 having raceways defined therein and integrated together with the inner race segment 1B, and the other inner race segment 1A.

The hub wheel 6 is coupled with one (for example, an outer race) of opposite ends of a constant speed universal joint 7, and a wheel (not shown) is connected to a radial flange 6a of the hub wheel 6 by means of a plurality of bolts 8.

The outer member 2 is in the form of a bearing outer race and is fitted to a housing (not shown) which may be, for example, a knuckle of a suspension system. The rolling elements 3 of each row are retained by a retainer or cage 4.

FIG. 3 illustrates, on an enlarged scale, the sealing device 5 equipped with the magnetized encoder. This sealing device 5 includes first and second annular sealing plates 11 and 12 fitted respectively to the inner member 1 and the outer member 2. These sealing plates 11 and 12 are fitted in position under interference fit around and inside the inner member 1 and the outer member 2, respectively. Each of the sealing plates 11 and 12 is of a generally L-shaped sectional shape, including a cylindrical portion 11a or 12a and a radial upright portion 11b or 12b. With the first and second sealing plates 11 and 12 fitted around and inside the inner and outer members 1 and 2, respectively, the first and second sealing plates 11 and 12 confront with each other with the respective radial upright portions 11a and 12a spaced a distance from each other in a direction axially of the wheel bearing assembly.

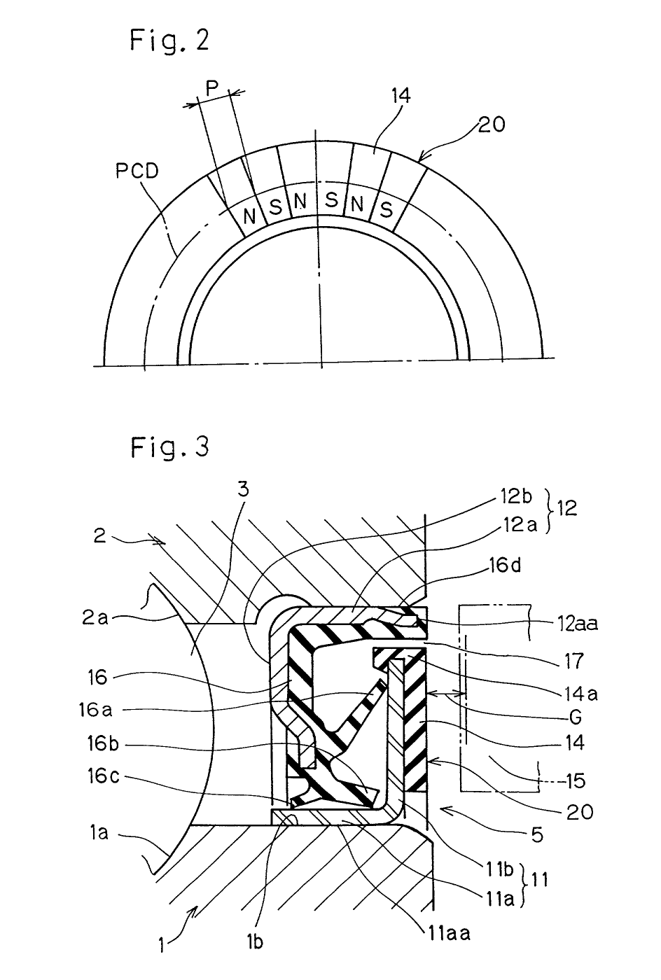

The first sealing plate 11 is mounted inside one of the inner and outer members 1 and 2 which is a rotatable member, that is, the inner member 1 and defines a slinger. The radial upright portion 11b is positioned on an outer side of the wheel bearing assembly remote from the rows of the rolling elements 3, and has its outer surface to which an elastic member 14 mixed with a powder of magnetic particles is bonded by vulcanization. This elastic member 14 forms a part of the magnetized encoder 20 which serves as a pulsar ring in cooperation with the first sealing plate 1 and is a so-called rubber magnet in which as best shown in FIG. 2, a series of alternating N and S poles are formed in a direction circumferentially thereof. Each neighboring poles are spaced a predetermined pitch p from each other at the pitch circle PCD. When the magnetic sensor 15 for detecting polarities of the magnetized encoder 20 is positioned in fact-to-face relation with the elastic member 14 of the magnetized encoder 20 with a gap G intervening therebetween as shown in FIG. 3, the rotary encoder for the detection of the wheel rotational speed can be obtained.

The elastic member 14 has an end cover portion 14a formed integrally therewith and adapted to cover a radially outer edge portion of the radial upright portion 11b of the first sealing plate 11, extending from the outer surface thereof onto an inner surface thereof over the radially outer edge of the radial upright portion 11b. It is, however, to be noted that the end cover portion 14a may not be always essential and may therefore be dispensed with.

The second sealing plate 12 is provided with a side lip 16a slidingly engaged with the radial upright portion 11b of the first sealing plate 11, and a pair of radial lip 16b and 16c slidingly engaged with the cylindrical portion 11a of the first sealing plate 11. These lips 16a to 16c are integral parts of an elastic member 16 that is bonded to the second sealing plate 12 by vulcanization. The number of the lips 16a to 16c formed in the second sealing plate 12 may be arbitrarily chosen, but in the illustrated embodiment the single side lip 16a and the two radial lips 16c and 16b positioned inner and outer sides in the direction axially of the wheel bearing assembly are employed. The second sealing plate 12 is shown as carrying the elastic member 16 at a mounting portion that is mounted on the outer member 1 which is a stationary member. In other words, the elastic member 16 has an end cover portion 16d covering an outer end 12aa of the cylindrical portion 12a, extending from an inner peripheral surface of the cylindrical portion 12a onto an outer peripheral surface portion over the outer end 12aa of the cylindrical portion 12a, with the end cover portion 16d intervening in the mounting portion between the second sealing plate 12 and the outer member 1. The outer end 12aa of the cylindrical portion 12a of the second sealing plate 12 is thin-walled to have a wall thickness smaller than that of the remaining part of the cylindrical portion 12a and is bent radially inwardly so as to converge outwardly of the wheel bearing assembly, with the end cover portion 16d covering such outer bent end 12aa of the cylindrical portion 12a of the second sealing plate 12. It is, however, to be noted that the end cover portion 16d although shown as formed integrally with the elastic member 16 may be a part separate from the elastic member 16.

The cylindrical portion 12a of the second sealing plate 12 and the radially outer edge of the radial upright portion 11b of the first sealing plate 11 are spaced a slight radial gap which in turn defines a labyrinth seal 17. Where the end cover portions 14a and 16d are provided in the elastic members 14 and 16 of the first and second sealing plates 11 and 12, respectively, such as shown, the labyrinth seal 17 referred to above will be defined in a gap defined between the end cover portions 14a and 16d.

Examples of materials for the various component parts will now be discussed. The inner member 1, the outer member 2 and the rolling elements 3 are all made of carbon steel such as, for example, bearing-grade steel. The first sealing plate 11 is prepared from a steel plate of a magnetic material such as, for example, ferrite steel plate (SUS430 type according to the Japanese Industrial Standards (JIS)) or a rolled steel plate which has been subjected to an antirust treatment. The second sealing plate 12 is prepared from a steel plate, for example, austenite stainless steel plate which is a non-magnetic material (SUS 304 type) or a rolled steel plate which has been subjected to an antirust treatment. By way of example, the first sealing plate 11 may be prepared from the ferrite steel plate whereas the second sealing plate 12 may be prepared from the austenite stainless steel.

The elastic material 14 is made of a material containing rubber as a base material, for example, a heat resistant nitrile rubber, acrylic rubber or fluorine containing rubber, mixed with a powder of magnetic material. For the powder of magnetic material, ferrite may be employed.

The magnetized encoder 20 have the following initial magnetic characteristic under the following condition for the thermal endurance test.

The condition for the thermal endurance test includes repetition of 1,000 thermal cycles each consisting of heating at 120° C. for one hour followed by cooling at −40° C. for one hour. The condition for the thermal endurance test corresponds to the condition according to the actual specification.

The initial magnetic characteristics are, where the air gap is 2.0 mm:

Single pitch deviation 15: ±2% or less

Magnetic flux density: ±3 mT or higher.

The air gap referred to above is intended to speak of the air gap G shown in FIG. 3 and represents the distance from the position where detecting elements are embedded to the surface of the encoder, that is, the distance from a surface of a magnetic detecting element of the magnetic sensor 15 to a surface of the elastic member 14.

It is to be noted that if the radial upright portion 11b of the first sealing plate 11 oscillates in a circumferential direction, the air gap G between the elastic member 14 rigid with the radial upright portion 11b and having the magnetic poles and the magnetic sensor 15 confronting such elastic member 14 varies. The oscillation of the radial upright portion 11b in the circumferential direction is intended to means a maximum axial positional displacement between arbitrary two circumferential positions at the outer surface of the radial upright portion 11b. If the air gap G expands axially, the single pitch deviation will become worse, resulting in reduction in accuracy with which the rotational speed is detected. For this reason, the circumferential oscillation is preferred to be restricted to a value not greater than 1 mm and, by so doing, the single pitch deviation can be suppressed to ±2% (4% in terms of range) or less.

The single pitch deviation and the magnetic flux density referred to above could be obtained by properly selecting a material for the base rubber material for the elastic member 14, a material for the powder of the magnetic material and the mixing ratio thereof. The mixing ratio referred to previously is measured in terms of percent by weight of the amount of the magnetic powder relative to the amount of the elastic member.

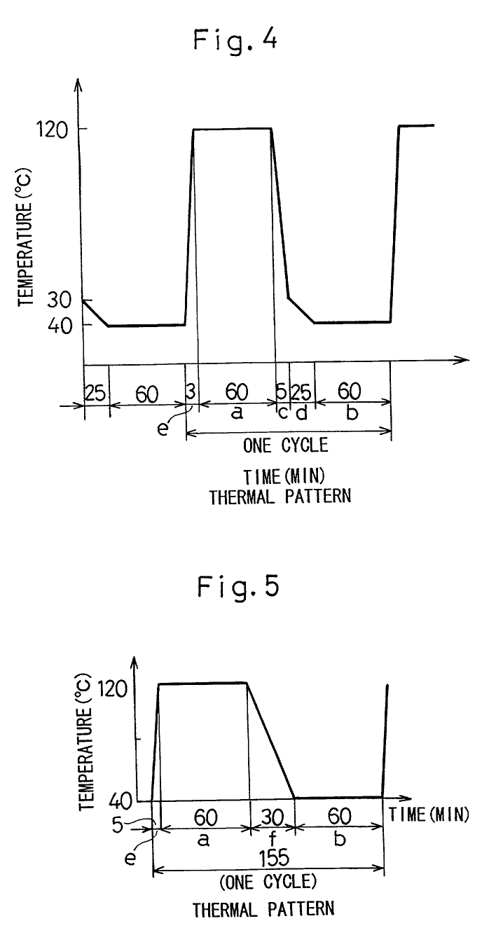

The thermal pattern of the thermal cycles discussed above is specifically such as shown in, for example, FIG. 4 or FIG. 5.

The thermal pattern shown in the example of FIG. 4 is such that during the temperature decreasing interval from a 120° C. constant temperature heating period a to a −40° C. constant temperature cooling period b, a quenching period c and the subsequent annealing period d are employed. During the quenching period c, the temperature is lowered down to −30° C. The temperature decreasing interval lasts for 30 minutes, including 5 minutes for the quenching period c and 25 minutes for the annealing period d. The temperature increasing interval e starting from the constant temperature cooling period b to a constant heating period a lasts for 3 minutes, and the temperature is increased at a predetermined ramp rate. One cycle lasts for 153 minutes.

The thermal pattern shown in the example of FIG. 5 is such that during the entire temperature decreasing interval f ranging from the 120° C. constant temperature heating period a to the −40° C. constant temperature cooling period b, the temperature is lowered at a predetermined lowering rate. The temperature increasing interval starting from the constant temperature cooling period b to the constant temperature heating period a lasts for 5 minutes with the temperature increased at a predetermined ramp rate. One cycle continues for 155 minutes.

Although either of these thermal patterns shown in FIGS. 4 and 5, respectively, may be employed, the thermal pattern shown in FIG. 4 is rather efficient in terms of time.

According to the foregoing structure, since the elastic member 14, mixed with the magnetic powder and having the alternating N and S poles developed in the circumferential direction thereof, is bonded by vulcanization to the radial upright portion 11b of the first sealing plate 11, the magnetized encoder 20 is formed by this elastic member 14 and the first sealing plate 11 and, accordingly the rotational speed can be detected by the magnetic sensor 15 disposed in face-to-face relation therewith.

With respect to the sealing between the inner and outer members 1 and 2, it can be achieved by a sliding contact exhibited by the seal lips 16a to 16c provided in the second sealing plate 12 and the labyrinth seal 17 defined by the radial gap between the cylindrical portion 12a of the second sealing plate 12 and the radial outer edge of the radial upright portion 11b of the first sealing plate 11.

Since under the above discussed condition for the thermal endurance test corresponding to the actual specification the magnetized encoder 20 has the above discussed initial characteristics as regards the above described single pitch deviation and the magnetic flux density, the initial magnetic characteristics can be retained even under the severe condition of use that prevails around the vehicle wheel. Accordingly, the accuracy with which the rotational speed can be detected can be maintained even under the severe temperature environment.

As a result of the tests, it has been found that where the standard nitrile rubber was employed as a material for the base rubber for the elastic member 14, fine cracking occurred under the above described thermal endurance test condition, with consequent failure to satisfy the above described initial magnetic characteristics. It is to be noted that, with the seal made of the standard nitrile rubber (with no magnetic powder mixed therein), there was no problem associated with occurrence of the fine cracking under the above described test condition, but with the seal made of the nitrile rubber mixed with the magnetic powder, occurrence of the fine cracking was observed.

However, where the heat resistance nitrile rubber was employed as the base material, no cracking was found even in the elastic member 14 mixed with the magnetic powder. On the other hand, even where the base material for the elastic member 14 was employed in the form of any of the acrylic rubber and the fluorine containing rubber, it is expected that no fine cracking will occur even under the above described thermal endurance test condition.

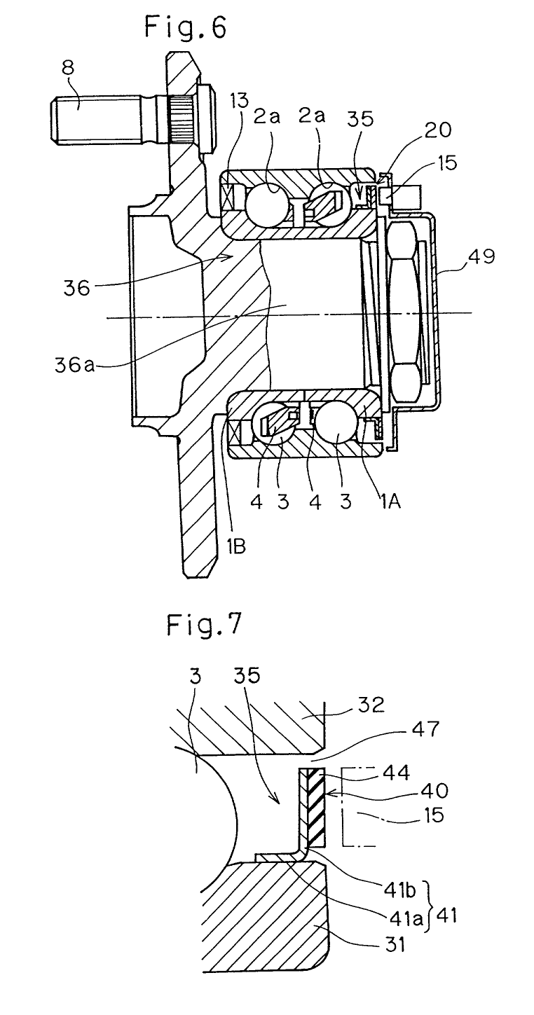

FIGS. 6 and 7 illustrate a second preferred embodiment of the present invention. In this embodiment, the present invention is applied to the wheel bearing assembly for the support of a driven wheel. Even in this embodiment, the magnetized encoder is of a type concurrently serving as a sealing slinger. Unlike the previously described embodiment, a stud shaft 36a of the hub wheel 36 forming a part of the inner member 31 in the embodiment shown in FIGS. 6 and 7 is not coupled with the constant speed universal joint and, instead, has a free end adjacent a vehicle body structure covered by a generally cap-like shroud 49. This shroud 49 has a radially outwardly extending annular peripheral flange that is used to close an annular inlet leading to the annular space between the inner member 31 and the outer member 32. The inner member 31 serves as a rotary member whereas the outer member 32 serves as a stationary member, as is the case with the inner and outer members 1 and 2 in the previously described embodiment.

The sealing device 35 equipped with the magnetized encoder disposed at one end of the annular space between the inner and outer members 31 and 32 defines a labyrinth seal effective to minimize any possible leakage of grease within the bearing assembly. In other words, the sealing device 35 is made up of a generally L-sectioned sealing plate 41 including a cylindrical portion 41a and a radial upright portion 41b extending radially outwardly from the cylindrical portion 41a, and an elastic member 44 secured to the radial upright portion 41b of the sealing plate 41. This sealing plate 41 is mounted under interference fit on the inner member 31 with a radially outer edge of the radial upright portion 41b spaced a slight distance radially inwardly from the inner peripheral surface of the outer member 32. The elastic member 44 employed in this embodiment is substantially identical in structure with the elastic member 14 described in connection with the previous embodiment of the present invention. In this embodiment, the sealing plate 41 and the elastic member 44 altogether constitute the magnetized encoder 40 which concurrently defines the sealing device 35. The magnetic sensor 15 confronting the elastic member 44 is fitted to the shroud 49.

According to the embodiment shown in FIGS. 6 and 7, the sealing device 35 defines the labyrinth seal effective to minimize any possible leakage of the grease within the bearing assembly as hereinbefore described. Even in this design, the elastic member 44 is effective to retain the above discussed initial characteristics, as regards the above described single pitch deviation and the magnetic flux density, under the above described thermal endurance test condition corresponding to the actual specification, the initial magnetic characteristics can be retained even under the severe condition of use that prevails around the vehicle wheel.

In this embodiment, other structural features than those described above are similar to those described in connection with the previous embodiment with reference to FIGS. 1 to 5.

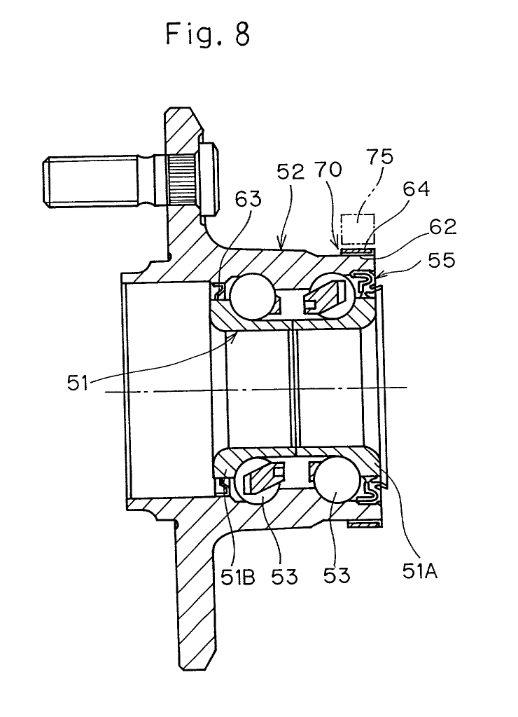

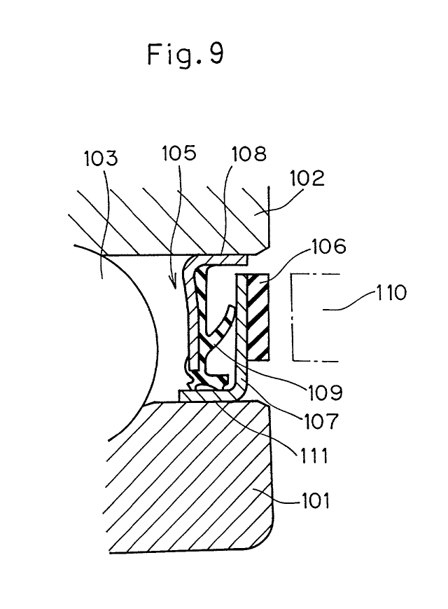

FIG. 8 illustrates a third preferred embodiment of the present invention. In this embodiment, the present invention is applied to the wheel bearing assembly for the support of the driven wheel, however the magnetized encoder of a radial type is employed.

The wheel bearing assembly shown in FIG. 8 includes inner and outer members 51 and 52, two rows of rolling elements 53 rollingly accommodated between the inner and outer members 51 and 52, sealing devices 55 and 63 sealing opposite ends of the annular space defined between the inner and outer members 51 and 52. The magnetized encoder 70 separate from the sealing device 55 is provided on one end of the wheel bearing assembly remote from the driven wheel. The inner and outer members 51 and 52 have respective raceways each being in the form of an annular groove for accommodating the corresponding row of the rolling elements 53.

The inner member 51 is comprised of a pair of split inner race segments 51A and 51B, and a fixed axle (not shown) fitted inside respective inner peripheral surface of the inner race segments 51A and 51B. The outer member 52 serves as a rotary member and is comprised of a bearing outer race integrated together with and therefore serving as a hub wheel.

On an outer periphery of one end of the outer member 52 the above described magnetized encoder 70 is mounted fixedly. This magnetized encoder 70 is made up of a metallic ring member 62 mounted fixedly on the outer periphery of the outer member 52 and an elastic member 64 provided on an outer peripheral surface of the metallic ring member 62. The elastic member 64 is in the form of a thin walled ring member having a radial wall thickness smaller than the width thereof as measured in a direction axially thereof. As is the case with the elastic member 14 employed in the first embodiment of the present invention, this elastic member 64 has a circular row of alternating N and S magnetic poles formed therein in the circumferential direction thereof and is a so-called rubber magnet. It is, however, to be noted that the direction in which magnetic fluxes develop between the N and S poles lies in a direction radially of the elastic member 64. This elastic member 64 is made of the same material as that for the elastic member 14 in the first embodiment and is effective to retain the same initial magnetic characteristics as those retained by the elastic member 14 used in the first embodiment. The ring member 62 is made of the same material as that for the sealing plate 11 (FIG. 3) employed in the first embodiment. The magnetic sensor 75 cooperable with the magnetized encoder 70 is supported by a stationary member in face-to-face relation with the magnetized encoder 70.

Even in the embodiment shown in FIG. 8, since the elastic member 64 is effective to the above described initial characteristics as regards the above described single pitch deviation and the magnetic flux density, under the above described thermal endurance test condition corresponding to the actual specification, the initial magnetic characteristics can be maintained even under the severe condition of use that prevails around the vehicle wheel.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

What is claimed is:

1. A wheel bearing assembly which comprises:
an inner member;
an outer member;
at least one circumferential row of rolling elements rollingly interposed between the inner and outer members;
a sealing device for sealing an annular end space defined between the inner and outer members; and
a magnetized encoder mounted on one of the inner and outer members which serves as a rotary member and including an elastic member made of a base material mixed with a powder of magnetic material, said elastic member being bonded by vulcanization to the magnetized encoder and having a series of alternating magnetic poles of opposite polarities formed in a direction circumferentially of the rotary member;
wherein under a thermal endurance test condition in which the magnetized encoder is subjected to 1,000 thermal cycles each consisting of heating at 120° C. for one hour followed by cooling at −40° C. for one hour, the magnetized encoder retains the following initial magnetic characteristics when an air gap defined between the magnetized encoder and a magnetic sensor for detecting the magnetic poles thereof is 2.0 mm:
Single pitch deviation: ±2% or less and
magnetic flux density: ±3 mT or higher.

2. The wheel bearing assembly as claimed in claim 1, wherein the single pitch deviation within that range and the magnetic flux density within that range are obtained by selecting materials for the base material of the elastic member, and for the powder of the magnetic material, and/or adjusting a mixing ratio of the magnetic material to the base material (wt %).

3. The wheel bearing assembly as claimed in claim 1, wherein the magnetized encoder forms the sealing device.

4. The wheel bearing assembly as claimed in claim 3, wherein the magnetized encoder has a generally L-shaped section including a cylindrical portion mounted on the rotary member and a radial upright portion extending radially outwardly from the cylindrical portion, said radial upright portion having a radial outer edge spaced a slight distance from the other of the inner and outer members which serves as a stationary member.

5. The wheel bearing assembly as claimed in claim 3, wherein the sealing device includes first and second annular sealing plates fitted to members of the inner and outer members that are different from each other;
wherein said first and second annular sealing plates are of a generally L-shaped section each including a cylindrical portion and a radial upright portion and confront with each other, wherein the first sealing plate is mounted on one of the inner and outer members which serves as the rotary member with the radial upright portion thereof positioned on an outer side of the bearing assembly;
wherein said elastic member mixed with the powder of the magnetic material is bonded by vulcanization to the radial upright portion of the first sealing plate and has the alternating magnetic poles of the opposite polarities defined therein in the direction circumferentially thereof;
wherein the second sealing plate is provided with a side lip slidingly engaged with the radial upright portion of the second sealing plate and a radial lip slidingly engaged with the cylindrical portion of the second sealing plate; and
wherein the radial upright portion of the first sealing plate has a radial outer edge spaced the slight distance radially from the cylindrical portion of the second sealing plate.

6. The wheel bearing assembly as claimed in claim 1, wherein the elastic member is made of a heat resistant nitrile rubber.
